(19) United States
(12) Patent Application Publication
(10) Pub. No.: US 2008/0096004 A1
(43) Pub. Date: Apr. 24, 2008

(54) Foamed polymer fiber composite lumber

(75) Inventor: William H. Crostic, Simpsonville, SC (US)

Correspondence Address: NIXON & VANDERHYE, PC, 901 NORTH GLEBE ROAD, 11TH FLOOR, ARLINGTON, VA, 22203, US

(73) Assignee: Guardian Building Products, Inc., Greer, SC (US)

(21) Appl. No.: 11/585,333

(22) Filed: Oct. 24, 2006

(51) Int. Cl. B32B 5/22

(52) U.S. Cl. 428/317.9; 428/74

(57) ABSTRACT

Certain example embodiments of this invention relate to a composite lumber product include from about (i) 38-46% wood fiber, (ii) 0.2-5.0% foaming agent, and (iii) 46-60% polymer such as homopolymer polypropylene. Optionally, the lumber product may also include one or more of from about: (iv) 0.5 to 5% lubricant, (v) 0.5 to 6% pigment, and/or (vi) 0.4 to 5.0% coupling agent. Surprisingly, it has been found that such a composite lumber product is surprisingly less subject to moisture absorption thereby leading to a more stain resistant product and a product less likely to absorb moisture (less weight gain) during wet environmental conditions. Moreover, such a composite lumber product is easier to cut/saw, and easier to screw into, thereby leading to a more user-friendly product.

This application relates to composite lumber. In certain example embodiments of this invention, composite lumber includes a lesser amount of wood fiber and an increased amount of polymer(s).

### BACKGROUND OF THE INVENTION

Composite or synthetic lumber has been used as a substitute for pure wood lumber in areas where wood can deteriorate quickly due to environmental conditions (e.g., decking applications). Although in the past, its commercialization was limited by costs, modem recycling techniques and low cost extrusion manufacturing capabilities have permitted greater penetration by polymer-fiber composite materials into commercial and residential markets. One such product manufactured under the trademark TREX, is made by Trex Company, LLC, and consists of a polyethylene-wood fiber blend which is extruded into board dimensions for decking applications. Polyethylene-wood composite boards in about 5/4 inch thickness or the like have rigidity to be used as decking planks.

Typical conventional composite lumber is made up of about 60% wood fiber and about 40% polymer. Unfortunately, typical conventional composite lumber is lacking in certain respects. For example, typical conventional composite lumber is difficult to saw/cut and screw into, and is subject to significant moisture absorption which leads to undesirable staining, change in stiffness, and/or weight gain in wet environmental conditions.

In view of the above, it will be appreciated that there exists a need in the art for a composite lumber product which is capable of solving one or more of the aforesaid problems. In particular, there exists a need in the art for a composite lumber product which is capable of one or more of: (a) being easier to saw/cut; (b) being easier to screw into; (c) less staining; (d) less change in stiffness; and/or (e) less weight gain in wet environmental conditions.

### BRIEF SUMMARY OF EXAMPLE EMBODIMENTS OF THE INVENTION

Certain example embodiments of this invention relate to a composite lumber product include from about (i) 38-46% wood fiber (more preferably from about 40-44%, and most preferably about 42%), (ii) 0.2-5.0% foaming agent (more preferably from about 0.4 to 1.5%, and most preferably about 0.7%), and (iii) 46-60% polymer such as homopolymer polypropylene (more preferably from about 48-56%, and most preferably about 52-53%). Optionally, the lumber product may also include one or more of from about: (iv) 0.5 to 5% lubricant (more preferably from about 1-2%), (v) 0.5 to 6% pigment (more preferably from about 1-4%), and/or (vi) 0.4 to 5.0% coupling agent (more preferably from about 0.6 to 2.5%, and most preferably about 1.4%).

Surprisingly, it has been found that a composite lumber product having the chemical make-up as set forth above is surprisingly less subject to moisture absorption thereby leading to a more stain resistant product and a product less likely to absorb moisture (less weight gain) during wet environmental conditions. Moreover, such a composite lumber product is easier to cut/saw, and easier to screw into, thereby leading to a more user-friendly product. Another example advantage is that the product has a reduced change in stiffness in wet conditions.

Moreover, in certain example embodiments of this invention, the composite lumber product is made in a manner and out of components such that there is improved encapsulation of the wood fiber by the polymer component (e.g., polypropylene). In certain example embodiments of this invention, at least about 50% of the wood fibers in the product are encapsulated by polymer, more preferably at least about 60%, even more preferably at least about 70%, still more preferably at least about 80%, and possibly at least about 90% of the wood fibers are encapsulated by the polymer. Such improved encapsulation of the wood fibers by the polymer leads to less moisture absorption, and thus better stain resistance, less change in stiffness, and less weight gain in wet conditions.

In certain example embodiments of this invention, there is provided a foamed composite lumber product comprising: from about (i) 38-46% wood fiber, (ii) 0.2-5.0% foaming agent, and (iii) 46-60% polymer; wherein at least about 50% of the wood fibers in the product are encapsulated by the polymer; and wherein following a thirty day immersion of the product in water the product has one or more of: (a) a MOE (modulus of elasticity) change of no more than about 15% due to the immersion of the product in water for thirty days, (b) a weight gain of no more than 3% due to the immersion of the product in water for thirty days, (c) a width dimension increase of no more than 0.4% due to the immersion of the product in water for thirty days, and/or (d) a thickness dimension increase of no more than 2.5% due to the immersion of the product in water for thirty days.

### BRIEF DESCRIPTION OF THE DRAWINGS

FIG. 1 is a graph comparing moisture absorption between an example of this invention (Ex. 1) versus a plurality of competitor products CE1-CE5.

FIG. 2 is a cross-sectional view of a solid composite lumber product according to an example embodiment of this invention.

### DETAILED DESCRIPTION OF THE INVENTION

Solid composite lumber according to different example embodiments of this invention may be used in applications such as decking boards, moldings, steps, window sills and sashes, and so forth. FIG. 2 is a cross sectional view of an example solid composite lumber product 3 according to an example embodiment of this invention.

This application relates to composite lumber. In certain example embodiments of this invention, composite lumber includes a lesser amount of wood fiber and an increased amount of polymer(s). Certain example embodiments of this invention relate to a composite lumber product include from about (i) 38-46% wood fiber (more preferably from about 40-44%, and most preferably about 42%), (ii) 0.2-5.0% foaming agent (more preferably from about 0.4 to 1.5%, and most preferably about 0.7%), and (iii) 46-60% polymer such as homopolymer polypropylene (more preferably from about 48-56%, and most preferably about 52-53%). Optionally, the solid lumber product may also include one or more of from about: (iv) 0.5 to 5% lubricant (more preferably from about 1-2%), (v) 0.5 to 6% pigment (more preferably from about 1-4%), and/or (vi) 0.4 to 5.0% coupling agent (more preferably from about 0.6 to 2.5%, and most preferably about 1.4%).

Surprisingly, it has been found that a composite lumber product having the chemical make-up as set forth above is surprisingly less subject to moisture absorption thereby leading to a more stain resistant product and a product less likely to absorb moisture (less weight gain) during wet environmental conditions. Moreover, such a composite lumber product is easier to cut/saw, and easier to screw into, thereby leading to a more user-friendly product.

Moreover, in certain example embodiments of this invention, the composite lumber product is made in a manner and out of components such that there is improved encapsulation of the wood fiber by the polymer component (e.g., polypropylene). In certain example embodiments of this invention, at least about 50% of the wood fibers in the product are encapsulated by polymer, more preferably at least about 60%, even more preferably at least about 70%, still more preferably at least about 80%, and possibly at least about 90% of the wood fibers are encapsulated by the polymer. Such improved encapsulation of the wood fibers by the polymer leads to less moisture absorption and thereby better stain resistance and less weight gain in wet conditions.

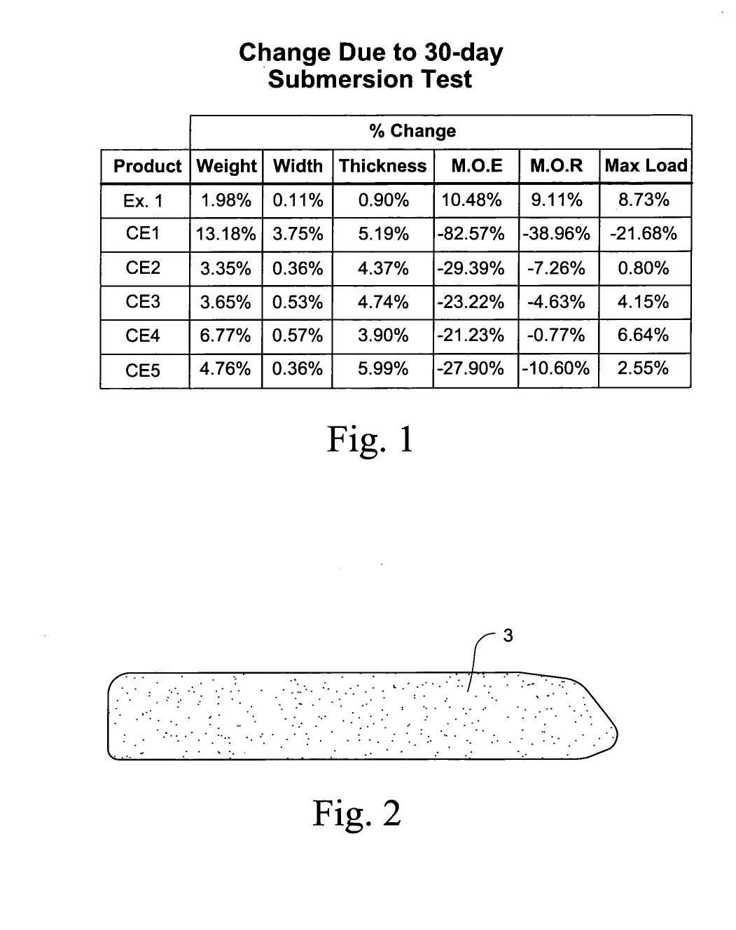

In certain example embodiments, a thirty day submersion test may be performed to demonstrate the reduced absorption associated with certain example embodiments of this invention. In certain example embodiments, a lumber product according to certain example embodiments of this invention may be submerged in water for thirty days. Consider a decking board having a width of about 5.5 inches, a thickness of about 1.1 inches, and a weight of about 1.98 pounds prior to submersion. After the thirty day submersion test (the products are removed from the submersion, and wiped dry), such products according to certain example embodiments of this invention have a weight gain of no more than 3%, more preferably no more than 2.5%, more preferably no more than 2.0% (e.g., see Ex. 1 in FIG. 1). In contrast, as shown in FIG. 1, competitor products of similar size have higher weight gains (e.g., 4.76% for Trex—CE5, 6.77% for ChoiceDeck—CE4, 3.65% for Weatherbest—CE3, and 3.35% for Tamko Evergrain—CE2). Note that Comparative Example 1 (CE1) is a hollow board from Elk which is not truly relevant due to its hollow nature.

Moreover, after the thirty day submersion test, such decking board products according to certain example embodiments of this invention (e.g., see Ex. 1) have a width dimension increase of no more than 0.4%, more preferably no more than 0.3%, more preferably no more than 0.2%, and most preferably no more than 0.15%. In contrast, as shown in FIG. 1, competitor products of similar size have higher width dimension increases evidencing higher moisture absorption (e.g., 0.36% for Trex—CE5, 0.57% for ChoiceDeck—CE4, 0.53% for Weatherbest —CE3, and 0.36% for Tamko Evergrain—CE2). Moreover, after the thirty day submersion test, as shown in FIG. 1, such decking board products according to certain example embodiments of this invention have a thickness dimension increase of no more than 2.5%, more preferably no more than 2.0%, more preferably no more than 1.5%, and most preferably no more than 1.0%. In contrast, competitor products of similar size have higher thickness dimension increases evidencing higher moisture absorption (e.g., 5.99% for Trex—CE5, 3.90% for ChoiceDeck—CE4, 4.74% for Weatherbest—CE3, and 4.37% for Tamko Evergrain—CE2).

Still further, as shown in FIG. 1, after the thirty day submersion test, such decking board products according to certain example embodiments of this invention (e.g., see Ex. 1) had the least change in MOE (modulus of elasticity) or the smallest change in stiffness; in particular such products after the thirty days had a MOE change of no more than about 15%, more preferably no more than about 14%, still more preferably no more than about 12% and possibly no more than about 11%. In contrast, competitor products of similar size have higher MOE change (e.g., −28% for Trex—CE5, −21% for ChoiceDeck—CE4, −23% for Weatherbest—CE3, and −29% for Tamko Evergrain—CE2; compared to +10.48% for an example of this invention (Ex. 1) evidencing less change in stiffness).

With respect to the polymer component of the composite lumber product, homopolymer polypropylene is a preferred material. However, in other example embodiments of this invention, the polymer component may be made of any other type of polypropylene, polyethylene, nylon, or polyester, or mixtures thereof, in the amounts described herein. With respect to the wood fiber component of the composite lumber product, various types of wood may be used; e.g., oak, spruce, maple, cedar, mixtures thereof, or the like. Moreover, it is possible to use another type of cellulosic material for the fiber component in alternative embodiments of this invention, in the amounts described herein.

From about 0.2-5.0% foaming agent (more preferably from about 0.4 to 1.5%, and most preferably about 0.7%) is provided in the composite lumber product in certain example embodiments of this invention. This may be a blowing agent in certain example instances. The foaming allows a reduced density and reduced weight for the lumber product. By using less wood, this enables foaming to be performed more easily in a more efficient manner. The blowing agent, or introduction of gaseous medium into the molten mixture of the resin and fiber in manufacturing, in the case of chemical blowing agents produces a series of trapped bubbles prior to thermo-foaming the mixture by extrusion or the like thereby causing foaming and a lower weight product. Example blowing agents (foaming agents) which may be used include, but are not limited to, material which releases gas upon thermal decomposition such as azo, N-niroso, carboxylate, dinitrosopentamethylene tetramine, p-toluene solfonyl semicarbazide, calcium oxalate, sodium bicarbonate, and so forth. The blowing agent(s) (foaming agent(s)) may be added to the polymer in several different ways such as by adding the solid powder, liquid or gaseous agent(s) directly to the resin in the extruder while the resin is in a molten state to obtain a substantially uniform dispersion of the agent in the molten plastic. It is possible to add the blowing agent(s) before the extrusion process and is in the form of a solid. The blowing agent(s) (foaming agent(s))

Various types of pigment may be used in certain example embodiments. Example pigment(s) include dyes, colored pigments, flyash, or mixtures thereof, in certain example embodiments of this invention. Such pigments may provide weatherability or a desirable color/look.

An example of making a solid composite lumber product according to an example embodiment of this invention is now described (see Ex. 1 in FIG. 1). Pre-pelletized or compounded wood concentrate is used. The wood concentrate includes about 60% 40 mesh wood fiber, 2% coupling agent, and 38% two melt homopolymer polypropylene. The wood concentrate is put into a hot dryer first and then transferred to a desiccant drier. The moisture level is reduced to less than 0.4%. At this point, four major ingredients (wood concentrate, polypropylene, pigment and lubricant) go into loss in weight feeders. They are fed into the throat of a single screw extruder in the ratios discussed above to generate a formulation discussed herein. A chemical blowing agent is fed through a throat feeder volumetrically to generate a desired level of density reduction. The molten composite material is then fed through the extruder where the blowing agent releases a combination of CO₂ and N₂ gases. This gas remains in solution until the melt leaves the die. At this time the melt swells as the gas comes out of solution and forms a cell structure. As the melt comes out of the die, it free foams into an aluminum calibrator. The calibrator contains and limits the foaming composite material and shapes it into a desired shape such as that of a decking board. The relationship between the die exit dimensions and the calibration dimensions determine the level of density reduction as well as quality of the part. The calibration may be long enough to set the skin of the part thick enough to prevent or reduce the likelihood of post-blowing (the product may stop swelling and substantially maintain a substantially constant dimensional stability). The board then proceeds down a series of spray tanks for cooling. It may then be cut to desired length and stacked. This unique method of manufacture, together with the component amounts, unexpectedly permits a composite lumber product to be made which has reduced moisture absorption and thus reduced staining, less size changes, and less weight gain in wet environmental conditions. These advantages are also combined with the advantage of reduced overall weight.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A foamed composite lumber product comprising:
from about (i) 38-46% wood fiber, (ii) 0.2-5.0% foaming agent, and (iii) 46-60% polymer;
wherein at least about 50% of the wood fibers in the product are encapsulated by the polymer; and
wherein following a thirty day immersion of the product in water the product has each of: (a) a MOE (modulus of elasticity) change of no more than about 15%, (b) a weight gain of no more than 3%, and (c) a width dimension increase of no more than 0.4% due to the immersion of the product in water for thirty days.

2. The foamed composite lumber product of claim 1, wherein following the thirty day immersion the product has a MOE change of no more than about 14%.

3. The foamed composite lumber product of claim 1, wherein following the thirty day immersion the product has a MOE change of no more than about 12%.

4. The foamed composite lumber product of claim 1, wherein following the thirty day immersion the product has a MOE change of no more than about 11%.

5. The foamed composite lumber product of claim 1, wherein following the thirty day immersion the product has a weight gain of no more than 2.5%.

6. The foamed composite lumber product of claim 1, wherein following the thirty day immersion the product has a weight gain of no more than 2.0%.

7. The foamed composite lumber product of claim 1, wherein following the thirty day immersion the product has a width dimension increase of no more than 0.3%.

8. The foamed composite lumber product of claim 1, wherein following the thirty day immersion the product has a width dimension increase of no more than 0.2%.

9. The foamed composite lumber product of claim 1, wherein the polymer comprises homopolymer polypropylene.

10. The foamed composite lumber product of claim 1, wherein at least about 60% of the wood fibers in the product are encapsulated by the polymer.

11. The foamed composite lumber product of claim 1, wherein at least about 70% of the wood fibers in the product are encapsulated by the polymer.

12. The foamed composite lumber product of claim 1, wherein at least about 80% of the wood fibers in the product are encapsulated by the polymer.

13. A foamed composite lumber product comprising:
from about (i) 38-46% wood fiber, (ii) 0.2-5.0% foaming agent, and (iii) 46-60% polymer;
wherein at least about 50% of the wood fibers in the product are encapsulated by the polymer; and
wherein following a thirty day immersion of the product in water the product has one or more of: (a) a MOE (modulus of elasticity) change of no more than about 15%, (b) a weight gain of no more than 3%, (c) a width dimension increase of no more than 0.4%, and/or (d) a thickness dimension increase of no more than 2.5% due to the immersion of the product in water for thirty days.

14. The foamed composite lumber product of claim 13, wherein following the thirty day immersion the product has a MOE change of no more than about 14%.

15. The foamed composite lumber product of claim 13, wherein following the thirty day immersion the product has a MOE change of no more than about 12%.

16. The foamed composite lumber product of claim 13, wherein following the thirty day immersion the product has a MOE change of no more than about 11%.

17. The foamed composite lumber product of claim 13, wherein following the thirty day immersion the product has a weight gain of no more than 2.5%.

18. The foamed composite lumber product of claim 13, wherein following the thirty day immersion the product has a thickness dimension increase of no more than 2.0%.

19. The foamed composite lumber product of claim 13, wherein following the thirty day immersion the product has a thickness dimension increase of no more than 1.5%.

20. The foamed composite lumber product of claim 1, wherein following the thirty day immersion the product has a thickness dimension increase of no more than 1.5%.

21. The foamed composite lumber product of claim 1, where the product further comprises from about 0.5 to 5% lubricant(s), from about 0.5 to 6% pigment(s), and from about 0.4 to 5.0% coupling agent(s).
